(19) United States
(12) Patent Application Publication
(10) Pub. No.: US 2017/0200182 A1
(43) Pub. Date: Jul. 13, 2017

(54) ANNOTATION OF AN ONLINE CONTENT ITEM BASED ON LOYALTY PROGRAMS

(71) Applicant: Google Inc., Mountain View, CA (US)

(72) Inventor: Jean-Yves Delort, Dubendorf (CH)

(21) Appl. No.: 14/323,184

(22) Filed: Jul. 3, 2014

(51) Int. Cl. G06Q 30/02

(52) U.S. Cl. CPC G06Q 30/0226

(57) ABSTRACT

A method for annotating a content item to be displayed on at least one client computing device having a display is described. The method includes generating a profile of a user associated with a client computing device. The profile identifies a first merchant that operates a loyalty program that the user has a membership account with. The method additionally includes retrieving a content item from memory to transmit to the client computing device. The content item is associated with products or services sold by a second merchant. Additionally, the method includes determining that the second merchant is associated with the loyalty program of the first merchant, annotating the content item to include an indication that purchasing one or more of the products or services from the second merchant will cause loyalty rewards to be applied to the membership account, and transmitting the annotated content item to the client computing device.

### BACKGROUND

This description relates to presenting online content items on client computing devices, and more particularly, to annotating an online content item to include information about a loyalty program.

In at least some known systems, a merchant operates a loyalty program to retain customers through incentives. More specifically, under the loyalty program, when a customer purchases goods and/or services from the merchant operating the program, the merchant assigns rewards, such as points, to a loyalty program account associated with the customer. In such systems, the customer may redeem the points for dollar-amount discounts on additional products and/or services sold by the merchant. In some such systems, one or more additional merchants function as a partner to the merchant offering the program such that if the customer purchases certain goods or services from the partner merchant, rewards are applied to the customer's account under the loyalty program.

### BRIEF DESCRIPTION OF DISCLOSURE

In one aspect, a method for annotating a content item to be displayed on at least one client computing device having a display is provided. The method is implemented by a server computing device that is communicatively coupled to a memory and to the at least one client computing device. The method includes generating a profile of a user associated with the client computing device. The profile identifies a first merchant that operates a loyalty program that the user has a membership account with. The method additionally includes retrieving a content item from the memory to transmit to the client computing device. The content item is associated with products or services sold by a second merchant. Additionally, the method includes determining that the second merchant is associated with the loyalty program of the first merchant, annotating the content item to include an indication that purchasing one or more of the products or services from the second merchant will cause loyalty rewards to be applied to the membership account, and transmitting the annotated content item to the client computing device.

In another aspect, a server computing device for annotating a content item to be displayed on at least one client computing device having a display is provided. The server computing device is communicatively coupled to a memory and to the at least one client computing device. The server computing device is configured to generate a profile of a user associated with the client computing device. The profile identifies a first merchant that operates a loyalty program that the user has a membership account with. The server computing device is additionally configured to retrieve a content item from the memory to transmit to the client computing device. The content item is associated with products or services sold by a second merchant. Additionally, the server computing device is configured to determine that the second merchant is associated with the loyalty program of the first merchant, annotate the content item to include an indication that purchasing one or more of the products or services from the second merchant will cause loyalty rewards to be applied to the membership account, and transmit the annotated content item to the client computing device.

In another aspect, a computer-readable storage device having processor-executable instructions embodied thereon, for annotating a content item to be displayed on at least one client computing device having a display, is provided. When executed by a server computing device communicatively coupled to a memory and to the at least one client computing device, the processor-executable instructions cause the server computing device to perform steps. The steps include generating a profile of a user associated with the client computing device, wherein the profile identifies a first merchant that operates a loyalty program that the user has a membership account with. The steps additionally include retrieving a content item from the memory to transmit to the client computing device, wherein the content item is associated with products or services sold by a second merchant. Additionally, the steps include determining that the second merchant is associated with the loyalty program of the first merchant, annotating the content item to include an indication that purchasing one or more of the products or services from the second merchant will cause loyalty rewards to be applied to the membership account, and transmitting the annotated content item to the client computing device.

In another aspect, a server computing device for annotating a content item to be displayed on at least one client computing device having a display is provided. The server computing device is communicatively coupled to a memory and to the at least one client computing device. The server computing device includes means for generating a profile of a user associated with the client computing device, wherein the profile identifies a first merchant that operates a loyalty program that the user has a membership account with. Additionally, the server computing device includes means for retrieving a content item from the memory to transmit to the client computing device, wherein the content item is associated with products or services sold by a second merchant. Additionally, the server computing device includes means for determining that the second merchant is associated with the loyalty program of the first merchant. Further, the server computing device includes means for annotating the content item to include an indication that purchasing one or more of the products or services from the second merchant will cause loyalty rewards to be applied to the membership account. In addition, the server computing device includes means for transmitting the annotated content item to the client computing device.

In another aspect, a server computing device as described above is provided, wherein the means for generating the profile further comprises means for determining that the user has the membership account associated with the loyalty program of the first merchant based on an electronic wallet associated with the user.

In another aspect, a server computing device as described above is provided, wherein the means for generating the profile further comprises means for identifying at least one reference to the loyalty program in an electronic message transmitted to a messaging account associated with the user, and means for determining, based at least in part on the identification of the reference in the electronic message, that the user has the membership account associated with the loyalty program of the first merchant.

In another aspect, a server computing device as described above is provided, wherein the means for generating the profile further includes means for detecting an installation of at least one application associated with the first merchant on the client computing device, and means for determining, based at least in part on the detected installation, that the user has a membership account associated with the loyalty program of the first merchant.

In another aspect, a server computing device as described above is provided, wherein the means for annotating the content item further includes means for including a link to a webpage of the second merchant that describes the loyalty program.

In another aspect, a server computing device as described above is provided, wherein the means for annotating the content item further includes means for detecting that the link has been activated on the client computing device.

In another aspect, a server computing device as described above is provided, wherein the server computing device further comprises means for receiving a search query transmitted from the client computing device, and means for transmitting the annotated content item in response to the search query.

In another aspect, a server computing device as described above is provided, wherein the server computing device further comprises means for selecting the content item from a plurality of content items stored in the memory based at least in part on the membership account.

In another aspect, a server computing device as described above is provided, wherein the means for annotating the content item further includes means for including in the annotation an indication that the products or services may be purchased using an electronic wallet.

In another aspect, a server computing device as described above is provided, wherein the means for annotating the content item further includes means for including instructions with the content item that, when executed by the client computing device, cause the client computing device to display a floating tag adjacent to the content item.

In another aspect, a server computing device as described above is provided, wherein the means for annotating the content item further includes means for including instructions with the content item that, when executed by the client computing device, cause the client computing device to display a menu adjacent to the content item, wherein the menu includes a reference to the loyalty program.

In another aspect, a server computing device as described above is provided, wherein the means for generating the profile further includes means for determining that the user has an interest in the loyalty program based on detecting that the user is following updates associated with the first merchant or has indicated support for the first merchant on a social networking site.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a diagram depicting an example networked environment.

FIG. 2 is a diagram of an example computing device that is used in the environment of FIG. 1.

FIG. 3 is a block diagram of an example relationship between a profile, sources of data used to generate the profile, and merchants associated with loyalty program data stored in the profile.

FIG. 4 is a block diagram of example communications among a client computing device, a content management system, and a publisher server computing device of the environment of FIG. 1.

FIG. 5 is a diagram of an example publication that includes an annotated content item.

FIG. 6 is a diagram of an example publication that includes an annotated content item in a menu format.

FIG. 7 is a flowchart of an example process for annotating a content item to be displayed on a client computing device.

FIG. 8 is a diagram of components of one or more example computing devices that may be used in the environment shown in FIG. 1.

Although specific features of various embodiments may be shown in some drawings and not in others, this is for convenience only. Any feature of any drawing may be referenced and/or claimed in combination with any feature of any other drawing.

### DETAILED DESCRIPTION OF DISCLOSURE

The following detailed description of implementations refers to the accompanying drawings. The same reference numbers in different drawings may identify the same or similar elements. Also, the following detailed description does not limit the claims.

Implementations of the methods and systems described herein annotate an advertisement (i.e., an online content item) displayed on a client computing device to include information about a loyalty program that a user of the client computing device may be a member of and may earn rewards for being such a member. More specifically, the system generates a profile of the user, including determining that the user has a membership account for a loyalty program of a first merchant (e.g., merchant A). The system additionally retrieves the content item to transmit to the client computing device associated with the user. The system determines that the content item is associated with a second merchant (e.g., merchant B) that is also associated with the loyalty program. For example, the second merchant may be partnering with the first merchant such that, if the user purchases products or services from the second merchant (e.g., merchant B), rewards under the loyalty program are applied to the membership account. Accordingly, the user is able earn merchant A loyalty rewards by purchasing products or services from merchant B. The system annotates the content item to include an indication that purchasing one or more of the products or services from the second merchant will cause loyalty rewards to be applied to the membership account. The system then transmits the annotated content item to the client computing device for display to the user.

In some implementations, the system determines which loyalty programs the user has an account with by: (i) reviewing loyalty card information stored in the user's electronic wallet, (ii) detecting one or more references to a loyalty program in an email sent to the user, (iii) detecting that one or more applications associated with merchants running loyalty programs (e.g., a merchant A app) are installed on the user's computing device (e.g., smartphone or tablet), and/or (iv) detecting actions of the user on one or more social networking sites that indicate the user's interest in the merchant operating the loyalty program (e.g., merchant A). In some implementations, the system uses the information regarding the membership account to select the content item. More specifically, the system may select a content item pertaining to goods and/or services of merchant B to annotate and transmit to the client computing device, because the user has a membership account for merchant A's loyalty program. In some implementations, the system transmits the content item as part of a search results page. In some implementations, the system includes a link in the content item that, when clicked on (“activated”), causes the client computing device to visit a webpage that describes the loyalty program. In some implementations, the system is configured to detect that the link has been activated on the client computing device, for example, by receiving a corresponding signal from the client computing device or a server computing device that hosts the webpage.

In some implementations, the system is configured to annotate the content item to include an indication that the products or services can be purchased using an electronic wallet. In some implementations, the system configures the annotation to be displayed as a floating tag adjacent to the content item. In some implementations, the system configures the annotation to be displayed as a menu that includes a reference (i.e., a menu item) to the loyalty program. The menu may include references to other loyalty programs associated with the second merchant as well.

In situations in which the systems discussed herein collect personal information about users, or may make use of personal information, the users may be provided with an opportunity to control whether programs or features collect user information (e.g., information about a user's social network, social actions or activities, profession, interests, preferences, or current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as a city, a ZIP code, or state level), so that a particular location of a user cannot be determined. Thus, the user may have control over how information is collected about the user and used by a content server.

As used herein, an element or step recited in the singular and preceded with the word “a” or “an” should be understood as not excluding plural elements or steps, unless such exclusion is explicitly recited. Furthermore, references to “one embodiment” of the subject matter disclosed herein are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least one of: (a) generating a profile of a user associated with a client computing device, wherein the profile identifies a first merchant that operates a loyalty program that the user has a membership account with; (b) retrieving a content item from a memory to transmit to the client computing device, wherein the content item is associated with products or services sold by a second merchant; (c) determining that the second merchant is associated with the loyalty program of the first merchant; (d) annotating the content item to include an indication that purchasing one or more of the products or services from the second merchant will cause loyalty rewards to be applied to the membership account; and (e) transmitting the annotated content item to the client computing device. The systems and methods described herein include annotating an online advertisement that is displayed to a user with a reference to a loyalty program that the user may be a member of. Such as system enables a user to easily see that an advertising merchant is associated with a loyalty program that the user is a member of so that the member is able to make purchases that will maximize loyalty points to the member.

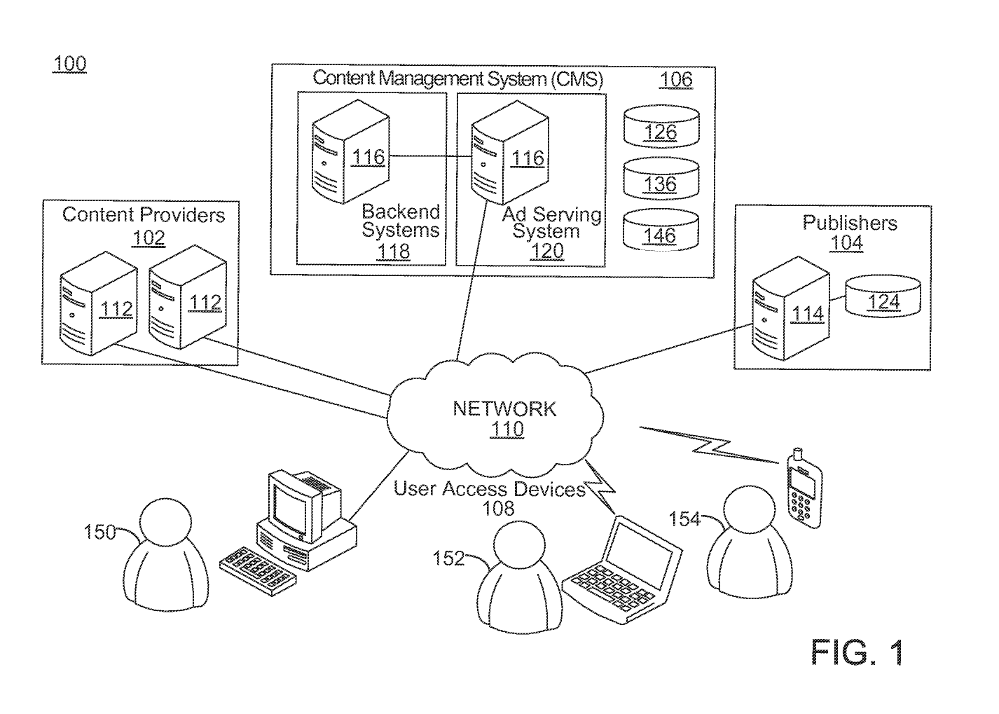

FIG. 1 is a diagram depicting an example networked environment. With reference to FIG. 1, an example networked environment 100 may include one or more content providers 102, one or more publishers 104, a content management system (CMS) 106, and one or more user access devices 108 (“client computing devices”), which may be coupled to a network 110. User access devices are used by users 150, 152, and 154. Each of the elements 102, 104, 106, 108 and 110 in FIG. 1 may be implemented or associated with hardware components, software components, or firmware components or any combination of such components. The elements 102, 104, 106, 108 and 110 can, for example, be implemented or associated with general purpose servers, software processes and engines, and/or various embedded systems. The elements 102, 104, 106 and 110 may serve, for example, as a content distribution network. In the example embodiment, content providers 102 include advertisers, and CMS 106 is an advertising management system.

The content providers 102 may include any entities that are associated with content (i.e., a content item or multiple content items). In some embodiments, the content includes any form of communication in which one or more products, services, ideas, messages, people, organizations or other items are identified and promoted (or otherwise communicated). Content is not limited to advertisements and commercial promotions. Rather, content may include public service announcements or any other types of notices, such as public notices published in printed or electronic press or broadcasts.

Content may be communicated via various mediums and in various forms. In some examples, content may be communicated through an interactive medium, such as the Internet, and may include graphical content (e.g., banner content), textual content, image content, audio content, video content, content combining one of more of any of such components, or any form of electronically delivered content. Content may include embedded information, such as embedded media, links, meta-information, and/or machine executable instructions. Content could also be communicated through RSS (Really Simple Syndication) feeds, radio channels, television channels, print media, and other media.

Content can refer to both a single “creative” and a “content group.” A creative refers to any entity that represents one content impression. A content impression refers to any form of presentation of content such that it is viewable/receivable by a user. In some examples, a content impression may occur when content is displayed on a display device of a user access device (i.e., a “client computing device”). A content group refers, for example, to an entity that represents a group of creatives that share a common characteristic, such as having the same content selection and recommendation criteria. Content groups can be used to create a content campaign.

The content providers 102 may provide (or be otherwise associated with) products and/or services related to content. The content providers 102 may include or be associated with, for example, merchants, retailers, wholesalers, warehouses, manufacturers, distributors, health care providers, educational establishments, financial establishments, technology providers, energy providers, utility providers, or any other product or service providers or distributors.

The content providers 102 may directly or indirectly generate, maintain, and/or analyze content, which may be related to products or services offered by or otherwise associated with the content providers 102. The content providers 102 may include or maintain one or more data processing systems 112, such as servers or embedded systems, coupled to the network 110. The content providers 102 may include or maintain one or more processes that run on one or more data processing systems.

The publishers 104 may include any entities that generate, maintain, provide, present and/or otherwise process publications in the environment 100. “Publishers,” in particular, include authors of publications, wherein authors may be individual persons, or, in the case of works made for hire, the proprietor(s) who hired the individual(s) responsible for creating the online publications. The term “publication” refers to various types of web-based, software application-based and/or otherwise presented information, including articles, discussion threads, reports, analyses, financial statements, music, video, graphics, search results, web page listings, information feeds (e.g., RSS feeds), television broadcasts, radio broadcasts, printed information, or any other form of information that may be presented to a user using a computing device such as one of user access devices 108.

In some implementations, the publishers 104 may include publishers with an Internet presence, such as online publication and news providers (e.g., online newspapers, online magazines, television websites, etc.), online service providers (e.g., financial service providers, health service providers, etc.), and the like. The publishers 104 can include software application providers, television broadcasters, radio broadcasters, satellite broadcasters, and other providers of publications. One or more of the publishers 104 may represent a publication network that is associated with the CMS 106.

The publishers 104 may receive requests from the user access devices 108 (or other elements in the environment 100) and provide or present publications to the requesting devices. The publishers may provide or present publications via various mediums and in various forms, including web based and non-web based mediums and forms. The publishers 104 may generate and/or maintain such publications and/or retrieve the publications from other network resources.

In addition to publications, the publishers 104 may be configured to integrate or combine retrieved publications with content that is related or relevant to the retrieved publication for display to users 150, 152, and 154. The relevant content may be provided from the CMS 106 and may be combined with a publication for display to users 150, 152, and 154. In some examples, the publishers 104 may retrieve a publication for display on a particular user access device 108 and then forward the publication to the user access device 108 along with code that causes content from the CMS 106 to be displayed to the user 150, 152, or 154. In other examples, the publishers 104 may retrieve a publication, retrieve relevant content (e.g., from the CMS 106 or the content providers 102), and then integrate the content and the publication to form a page for display to the user 150, 152, or 154.

As noted above, one or more of the publishers 104 may represent a publication network. In such an implementation, the content providers 102 may be able to present content to users through this publication network.

The publishers 104 may include or maintain one or more data processing systems 114, such as servers or embedded systems, coupled to the network 110. They may include or maintain one or more processes that run on data processing systems. In some examples, the publishers 104 may include one or more publication repositories 124 for storing publications and other information. A publisher 104 may also be a content provider 102.

The CMS 106 manages content and provides various services to the content providers 102, the publishers 104, and the user access devices 108. The CMS 106 may store content in a content repository 126 and facilitate the distribution or selective provision and recommendation of content through the environment 100 to the user access devices 108.

The CMS 106 may include one or more data processing systems 116, such as servers or embedded systems, coupled to the network 110. It can also include one or more processes, such as server processes. In some examples, the CMS 106 may include a content serving system 120 and one or more backend processing systems 118. The content serving system 120 may include one or more data processing systems 116 and may perform functionality associated with delivering content to publishers or user access devices 108. The backend processing systems 118 may include one or more data processing systems 116 and may perform functionality associated with identifying relevant content to deliver, processing various rules, performing filtering processes, generating reports, maintaining accounts and usage information, and other backend system processing. The CMS 106 can use the backend processing systems 118 and the content serving system 120 to selectively recommend and provide relevant content from the content providers 102 through the publishers 104 to the user access devices 108.

The CMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publications, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query.

The CMS 106 may include one or more interface or frontend modules for providing the various features to content providers, publishers, and user access devices. For example, the CMS 106 may provide one or more publisher front-end interfaces (PFEs) for allowing publishers to interact with the CMS 106. The CMS 106 may also provide one or more content provider front-end interfaces (CPFEs) for allowing content providers to interact with the CMS 106. In some examples, the front-end interfaces may be configured as web applications that provide users with network access to features available in the CMS 106.

The CMS 106 provides various content management features to the content providers 102. The CMS 106 features may allow users to set up user accounts, set account preferences, create content, select keywords for content, create campaigns or initiatives for multiple products or businesses, view reports associated with accounts, analyze costs and return on investment, selectively identify customers in different regions, selectively recommend and provide content to particular publishers, analyze financial information, analyze content performance, estimate content traffic, access keyword tools, add graphics and animations to content, etc.

The CMS 106 may allow the content providers 102 to create content and input keywords for which the content will appear. In some examples, the CMS 106 may provide content to user access devices or publishers when keywords associated with that content are included in a user request or a requested publication. The CMS 106 may also allow the content providers 102 to set bids for content. A bid may represent the maximum amount a content provider is willing to pay for each content impression, user click-through of content or other interaction with content. A click-through can include any action a user takes to select content. The content providers 102 may also choose a currency and monthly budget.

The CMS 106 may also allow the content providers 102 to view information about content impressions, which may be maintained by the CMS 106. The CMS 106 may be configured to determine and maintain the number of content impressions relative to a particular website or keyword. The CMS 106 may also determine and maintain the number of click-throughs for content as well as the ratio of click-throughs to impressions.

The CMS 106 may also allow the content providers 102 to select and/or create conversion types for content. A “conversion” may occur when a user consummates a transaction related to given content. A conversion could be defined to occur when a user clicks on content, for example a specific content item, is referred to the content provider's web page, and consummates a purchase there before leaving that web page. In another example, a conversion could be defined as the display of content to a user and a corresponding purchase on the content provider's web page within a predetermined time (e.g., seven days). The CMS 106 may store conversion data and other information in a conversion data repository 136.

The CMS 106 may allow the content providers 102 to input description information associated with content. This information could be used to assist the publishers 104 in determining content to publish. The content providers 102 may additionally input a cost/value associated with selected conversion types, such as a five dollar credit to the publishers 104 for each product or service purchased.

The CMS 106 may provide various features to the publishers 104. The CMS 106 may deliver content (associated with the content providers 102) to the user access devices 108 when users access publications from the publishers 104. The CMS 106 can be configured to deliver content that is relevant to publisher sites, publications, and publisher audiences.

In some examples, the CMS 106 may crawl publications provided by the publishers 104 and deliver content that is relevant to publisher sites, publications and publisher audiences based on the crawled publications. The CMS 106 may also selectively recommend and/or provide content based on user information and behavior, such as particular search queries performed on a search engine website. The CMS 106 may store such information in a general database 146. In some examples, the CMS 106 can add search to a publisher site and deliver content configured to provide appropriate and relevant content relative to search results generated by requests from visitors of the publisher site. A combination of these and other approaches can be used to deliver relevant content.

The CMS 106 may allow the publishers 104 to search and select specific products and services as well as associated content to be displayed with publications provided by the publishers 104. For example, the publishers 104 may search through content in the content repository 126 and select certain content for display with their publications.

The CMS 106 may be configured to selectively recommend and provide content created by the content providers 102 to the user access devices 108 directly or through the publishers 104. The CMS 106 may selectively recommend and provide content to a particular publisher 104 (as described in further detail herein) or a requesting user access device 108 when a user requests search results or loads a publication from the publisher 104.

In some implementations, the CMS 106 may manage and process financial transactions among and between elements in the environment 100. For example, the CMS 106 may credit accounts associated with the publishers 104 and debit accounts of the content providers 102. These and other transactions may be based on conversion data, impressions information and/or click-through rates received and maintained by the CMS 106.

“Computing devices”, for example user access devices 108, may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, head-mounted computing devices, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed content providers 102, publishers 104 and/or user access devices 108, which may be discrete, integrated modules or distributed systems. Similarly, the environment 100 is not limited to a single CMS 106 and may include any number of integrated or distributed CMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes running on separate machines or a single process running on a single machine.

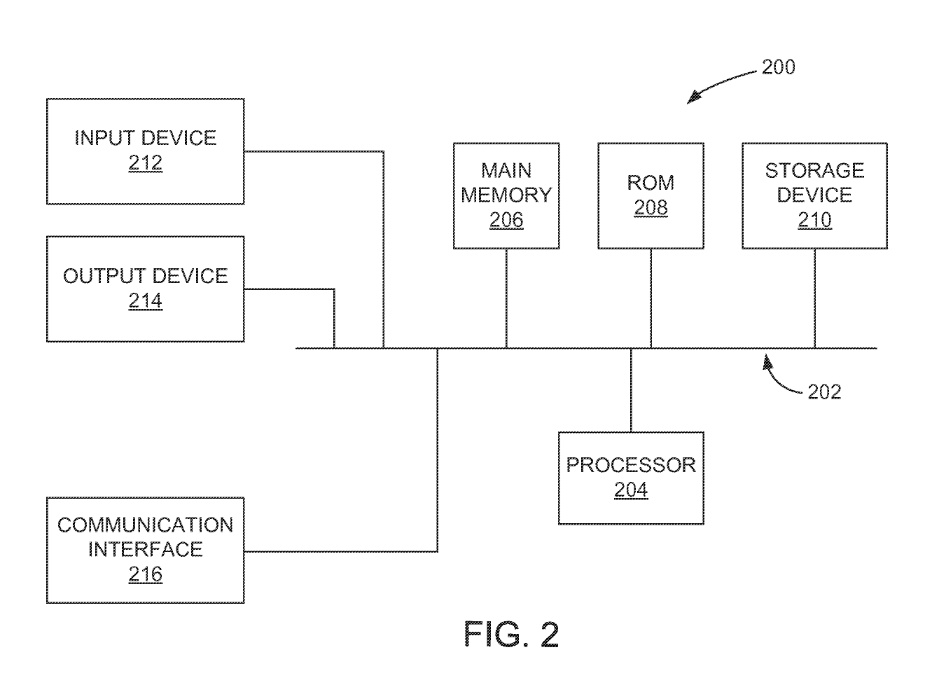

FIG. 2 shows an example of a computing device 200 intended to represent various forms of digital computers, such as laptops, desktops, workstations, personal digital assistants, servers, blade servers, mainframes, and other appropriate computers. Computing device 200 is also intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

In the example embodiment, computing device 200 could be user access device 108 or any of data processing devices 112, 114, or 116 (shown in FIG. 1). Computing device 200 may include a bus 202, a processor 204, a main memory 206, a read only memory (ROM) 208, a storage device 210, an input device 212, an output device 214, and a communication interface 216. Bus 202 may include a path that permits communication among the components of computing device 200.

Processor 204 may include any type of conventional processor, microprocessor, or processing logic that interprets and executes instructions. Processor 204 can process instructions for execution within the computing device 200, including instructions stored in the memory 206 or on the storage device 210 to display graphical information for a GUI on an external input/output device, such as display 214 coupled to a high speed interface. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

Main memory 206 may include a random access memory (RAM) or another type of dynamic storage device that stores information and instructions for execution by processor 204. ROM 208 may include a conventional ROM device or another type of static storage device that stores static information and instructions for use by processor 204. Main memory 206 stores information within the computing device 200. In one implementation, main memory 206 is a volatile memory unit or units. In another implementation, main memory 206 is a non-volatile memory unit or units. Main memory 206 may also be another form of computer-readable medium, such as a magnetic or optical disk.

Storage device 210 may include a magnetic and/or optical recording medium and its corresponding drive. The storage device 210 is capable of providing mass storage for the computing device 200. In one implementation, the storage device 210 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as main memory 206, ROM 208, the storage device 210, or memory on processor 204.

The high speed controller manages bandwidth-intensive operations for the computing device 200, while the low speed controller manages lower bandwidth-intensive operations. Such allocation of functions is for purposes of example only. In one implementation, the high-speed controller is coupled to main memory 206, display 214 (e.g., through a graphics processor or accelerator), and to high-speed expansion ports, which may accept various expansion cards (not shown). In the implementation, low-speed controller is coupled to storage device 210 and low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Input device 212 may include a conventional mechanism that permits computing device 200 to receive commands, instructions, or other inputs from a user 150, 152, or 154, including visual, audio, touch, button presses, stylus taps, etc. Additionally, input device may receive location information. Accordingly, input device 212 may include, for example, a camera, a microphone, one or more buttons, a touch screen, and/or a GPS receiver. Output device 214 may include a conventional mechanism that outputs information to the user, including a display (including a touch screen) and/or a speaker. Communication interface 216 may include any transceiver-like mechanism that enables computing device 200 to communicate with other devices and/or systems. For example, communication interface 216 may include mechanisms for communicating with another device or system via a network, such as network 110 (shown in FIG. 1).

As described herein, computing device 200 facilitates the presentation of content from one or more publishers, along with one or more sets of sponsored content, for example ads, to a user. Computing device 200 may perform these and other operations in response to processor 204 executing software instructions contained in a computer-readable medium, such as memory 206. A computer-readable medium may be defined as a physical or logical memory device and/or carrier wave. The software instructions may be read into memory 206 from another computer-readable medium, such as data storage device 210, or from another device via communication interface 216. The software instructions contained in memory 206 may cause processor 204 to perform processes described herein. Alternatively, hardwired circuitry may be used in place of or in combination with software instructions to implement processes consistent with the subject matter herein. Thus, implementations consistent with the principles of the subject matter disclosed herein are not limited to any specific combination of hardware circuitry and software.

The computing device 200 may be implemented in a number of different forms, as shown in the figure. For example, it may be implemented as a standard server, or multiple times in a group of such servers. It may also be implemented as part of a rack server system. In addition, it may be implemented in a personal computer such as a laptop computer. Each of such devices may contain one or more of computing device 200, and an entire system may be made up of multiple computing devices 200 communicating with each other.

The processor 204 can execute instructions within the computing device 200, including instructions stored in the main memory 206. The processor may be implemented as chips that include separate and multiple analog and digital processors. The processor may provide, for example, for coordination of the other components of the device 200, such as control of user interfaces, applications run by device 200, and wireless communication by device 200.

Computing device 200 includes a processor 204, main memory 206, ROM 208, an input device 212, an output device such as a display 214, a communication interface 216, among other components including, for example, a receiver and a transceiver. The device 200 may also be provided with a storage device 210, such as a microdrive or other device, to provide additional storage. Each of the components are interconnected using various buses, and several of the components may be mounted on a common motherboard or in other manners as appropriate.

Computing device 200 may communicate wirelessly through communication interface 216, which may include digital signal processing circuitry where necessary. Communication interface 216 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, WiFi, or other such transceiver (not shown). In addition, a GPS (Global Positioning system) receiver module may provide additional navigation- and location-related wireless data to device 200, which may be used as appropriate by applications running on device 200.

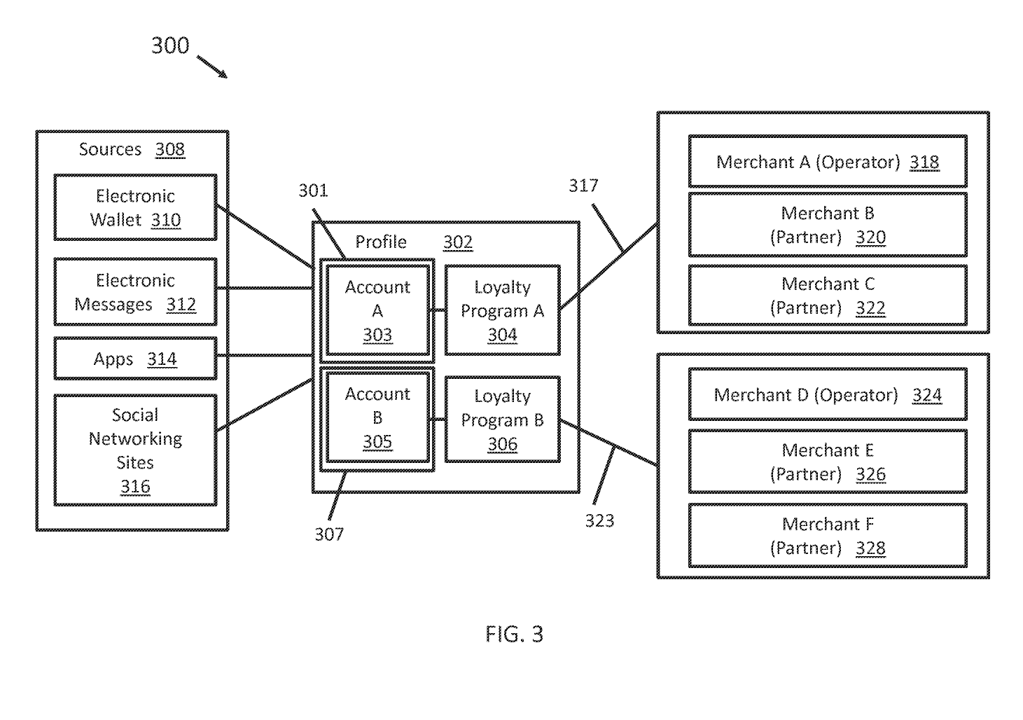

FIG. 3 is a block diagram of an example relationship 300 between a profile 302, sources 308 of data used to generate profile 302, and merchants 318, 320, 322, 324, 326, and 328 associated with loyalty program data 304 and 306 stored in profile 302. CMS 106 receives information from one or more of sources 308 and generates profile 302. Sources 108 include an electronic wallet 310, electronic messages 312, applications 314 associated with merchants, and one or more social networking sites 316 that a user, such as user 154, is associated with. Electronic wallet 310 includes data pertaining to loyalty program cards associated with user 154, of a user access device (“client computing device”) 108. More specifically, the electronic wallet 310 includes loyalty program card numbers and/or loyalty program account numbers associated with user 154. For example, electronic wallet 310 may include an account number for membership account A 303 and/or an account number for membership account B 305. In some implementations, electronic wallet 106 is stored by CMS 106, for example in general database 146. In other implementations, electronic wallet is stored in memory 206 and/or storage device 210 of client computing device 108 associated with user 154. In such implementations, client computing device 108 transmits all or a portion of electronic wallet 310 to CMS 106, for example after receiving a corresponding request message from CMS 106 and, at least in some implementations, after receiving authorization from user 154, for example through input device 212.

In addition, or alternatively, CMS 106 sources 308 include electronic messages 312 transmitted to or from client computing device 108 and/or an account associated with user 154. For example, an email transmitted to an account associated with user 154 may include an electronic receipt for purchases made by user 154 using loyalty rewards for a loyalty program, such as loyalty program A 304, a confirmation message that user 154 has enrolled in loyalty program A 304, or another reference to loyalty program A 304. CMS 106 may store electronic messages 312 on behalf of user 154, for example in an email account accessed by user 154 using client computing device 108. Electronic messages may additionally or alternatively include chat messages, text messages (e.g., short message service (SMS) messages) and/or other messages transmitted to or from client computing device 108 and/or an account associated with user 154. CMS 106 may be at least partially responsible for transmitting or storing such electronic messages 312, thereby enabling CMS 106 to detect references to loyalty program A 304. In other implementations, CMS 106 is not involved in transmitting or storing electronic messages 312, but such electronic messages 312 are stored and/or transmitted by one or more computing devices 200 that enable CMS 106 to access the electronic messages 312.

In some implementations, sources 308 additionally or alternatively include applications 314 installed to client computing device 108. For example, CMS 106 may include or be communicatively coupled to one or more servers that provide an online store from which client computing device 108 has downloaded and installed an application pertaining to a loyalty program, such as loyalty program A 304. For example, the application may pertain to merchant A 318, which operates loyalty program A 304. The application may provide information regarding products and/or services sold by merchant A 318, provide information about locations of merchant A 318 within a specific geographic area (i.e., zip code), and provide information about loyalty program A 304, such as information about rewards associated with loyalty program A 304. CMS 106 may detect a log entry stored, for example in database 146, indicating the downloading and installation of such applications 314 on client computing device 108. Additionally, or alternatively, in some implementations, CMS 106 may receive an indication transmitted from client computing device 108 identifying one or more of applications 314 operating on client computing device 108. For example, in some implementations, when client computing device 108 initially opens such an application 314, client computing device 108 transmits an indication to CMS 106 that the application 314 is running.

Sources 308 additionally include one or more social networking sites 316 that user 154 is associated with (e.g., has an account with). For example, user 154 may indicate approval of or interest in an article about a particular merchant, such as merchant A 318, by flagging the article on the social networking site 316. Additionally or alternatively, user 154 may indicate approval of or interest in merchant A itself, for example by indicating such approval or interest in an account or other representation of merchant A 318 and/or by following updates from merchant A 318 on the social networking site 316. CMS 106 is communicatively coupled to the one or more social networking sites 316 and detects such social networking actions for example by searching the social networking sites 316 for items that include a reference to user 154. In some implementations, CMS 106 operates one or more such social networking sites 316.

Using data from sources 308, CMS 106 generates profile 302 associated with user 154. Profile includes an indication 301 of the possible existence of membership account A 303 for loyalty program A 304 and an indication 307 of the possible existence of membership account B 305 for loyalty program B 306. More specifically, in some implementations, CMS 106 determines, from one of more of sources 308, a likelihood that user 154 has a membership account with one or more of loyalty programs 304 and 306. If the likelihood meets or a exceeds a predefined threshold (e.g., 50% likelihood), CMS 106 stores the indication 301 and/or 307 of the existence of the corresponding membership account (e.g., membership account A 303 and/or membership account B 305).

Profile 302 includes a first reference 317 that identifies a first set of merchants that are associated with loyalty program A 304, and a second reference 323 that identifies a second set of merchants that are associated with loyalty program B 306. Loyalty program A 304 is operated by merchant A 318. More specifically, merchant A 318 enables loyalty rewards earned by user 154 to be redeemed through merchant A 318. For example, merchant A 318 enables such rewards to be applied towards the purchase of products and/or services sold by merchant A 318. In addition, merchant B 320 and merchant C 322 are associated with loyalty program A 304. In other words, merchant B 320 and merchant C 322 are partners with merchant A 318 inasmuch as if user 154 purchases one or more products and/or services from merchant B 320 or merchant C 322, user 154 earns rewards under loyalty program A 304 that may be redeemed through merchant A 318.

Loyalty program B 306 is operated by merchant D 324. More specifically, merchant D 324 enables loyalty rewards earned by user 154 to be redeemed through merchant D 324. For example, merchant D 324 enables such rewards to be applied towards the purchase of products and/or services sold by merchant D 324. In addition, merchant E 326 and merchant F 328 are associated with loyalty program B 306. In other words, merchant E 326 and merchant F 328 are partners with merchant D 324 inasmuch as if user 154 purchases one or more products and/or services from merchant E 326 or merchant F 328, user 154 earns rewards under loyalty program B 306 that may be redeemed through merchant D 324.

In some implementations, the operator of each respective loyalty program transmits a message to CMS 106 indicating which merchants are partners for the loyalty program operated by the merchant. For example, merchant A 318 transmits a message to CMS 106 indicating that merchant B 320 and merchant C 322 are partners for loyalty program A 304. Similarly, merchant D 324 transmits a message to CMS 106 indicating that merchant E 326 and merchant F 328 are partners for loyalty program B 306. In other implementations, each partner merchant, for example each of merchant B 320, merchant C 322, merchant E 326, and merchant F 328 transmits a message to CMS 106 indicating their partnership in the respective loyalty program (i.e., loyalty program A 304 and loyalty program B 306). In some implementations, the message is transmitted through a user interface included, for example, in a web page generated by CMS 106. In other implementations, the message is transmitted as an email or in another format.

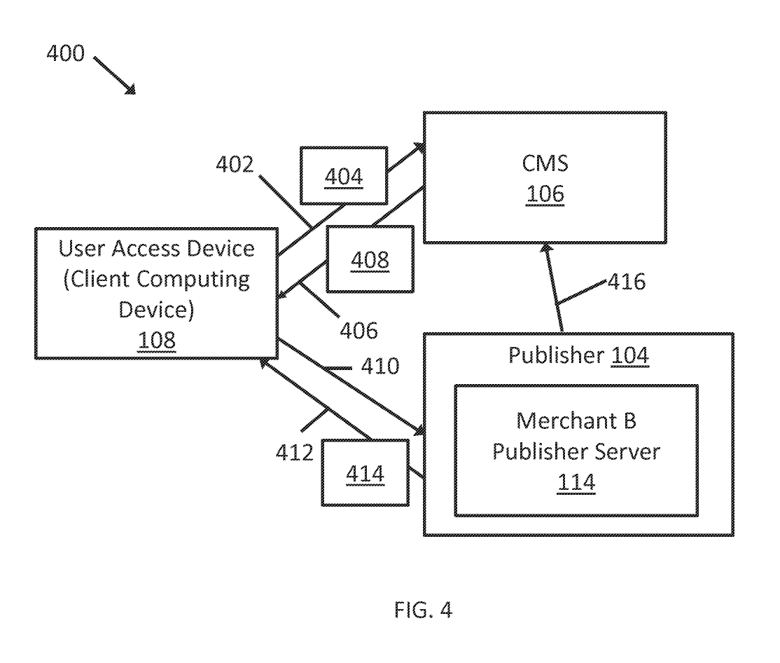

FIG. 4 is a block diagram of example communications 400 among client computing device 108, CMS 106, and publisher server computing device 114. More specifically, merchant B 320 operates publisher server computing device 114, which hosts a web site with information about products and services sold by merchant B 320. In addition, publisher server computing device 114 hosts a particular webpage 414 (a “landing page”) that describes the relationship between merchant B 320 and loyalty program A 304. More specifically, landing page 414 lists products and services offered by merchant B 320 that, if purchased, cause loyalty rewards to be applied to membership account A 303 for loyalty program A 304.

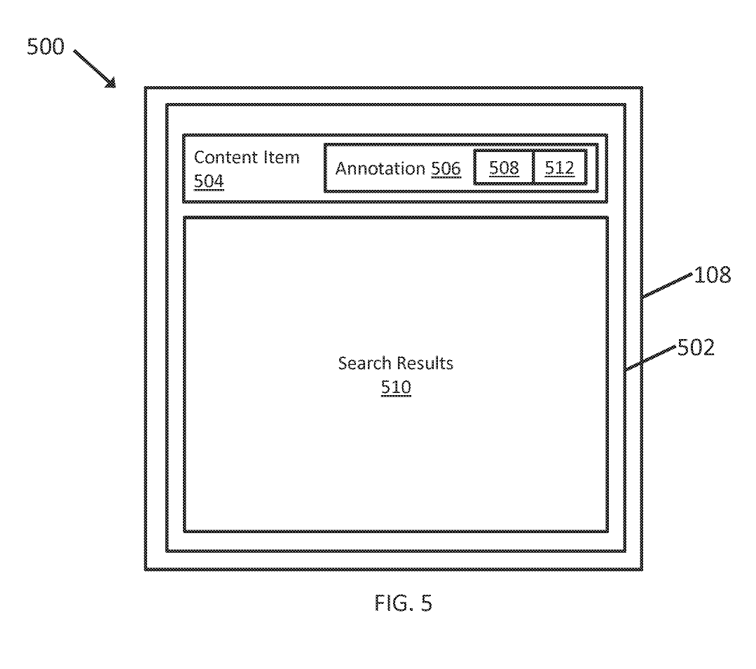

Initially, client computing device 108 transmits a search query 402 to CMS 106. Search query 402 includes one or more keywords 404. CMS 106 identifies that client computing device 108 is associated with profile 302, for example because client computing device 108 stores one or more cookies (not shown) in memory 206 or storage device 210 and transmits and indication of the association of client computing device 108 with profile 302 to CMS 106 before, after, or as part of search query 402. CMS 106 transmits a response 406 to client computing device 108 including a publication 408. More specifically, publication 408 includes search results and an annotated content item 504 (FIG. 5). Annotated content item 504 includes a link 508 (FIG. 5) to landing page 414 hosted by publisher server computing device 114. User 154 clicks on the link 508 and, in response, client computing device 108 transmits a request 410 to publisher server computing device 114 for landing page 414. After receiving request 410, publisher server computing device 114 transmits a response 412 that includes landing page 414 to client computing device 108. The landing page 414 describes products and services offered by merchant B 320 that, if purchased, would cause rewards associated with loyalty program A 304 to be awarded to the purchaser (e.g., user 154). In addition, publisher server computing device 114 transmits a notification 416 to CMS 106 that client computing device 108 accessed the landing page 414. In other words, the notification 416 indicates that the link 508 was clicked on or activated on client computing device 108. In other implementations, client computing device 108 transmits notification 416 to CMS 106.

FIG. 5 is a diagram 500 of an example publication 502 that includes an annotated content item 504. More specifically, publication 502 is an example implementation of publication 408 transmitted from CMS 106 as part of response 406 (FIG. 4). Publication 502 is displayed by client computing device 108 and, in addition to content item 504, includes search results 510 generated by CMS 106 based on search query 402. In some implementations, CMS 106 selects content item 504 from content repository 126 based at least in part on key words 404 included in search query 402. In some implementations, CMS 106 selects content item 504 based additionally on indication 301 of membership account A 303 in profile 302, the association of merchant B 320 to loyalty program A 304, and the association of client computing device 108 with profile 302, as described with reference to FIG. 4. Prior to transmitting content item 504 to client computing device 108, CMS 106 includes an annotation 506 in content item 504. Annotation 506 indicates that purchasing one or more of the products or services from merchant B 320 will cause loyalty rewards to be applied to the membership account (e.g., membership account A 303) of user 154. Annotation 506 includes a link 508 to landing page 414 (FIG. 4). Depending on the particular implementation, annotation 506 may appear adjacent to content item 504, for example to the left, the right, above, or below content item 504. In some implementations, annotation 506 appears as a floating tag adjacent to content item 504. In some implementations, annotation 506 includes a visual indication 512 that products or services associated with content item 504 may be purchased using an electronic wallet (e.g., electronic wallet 310).

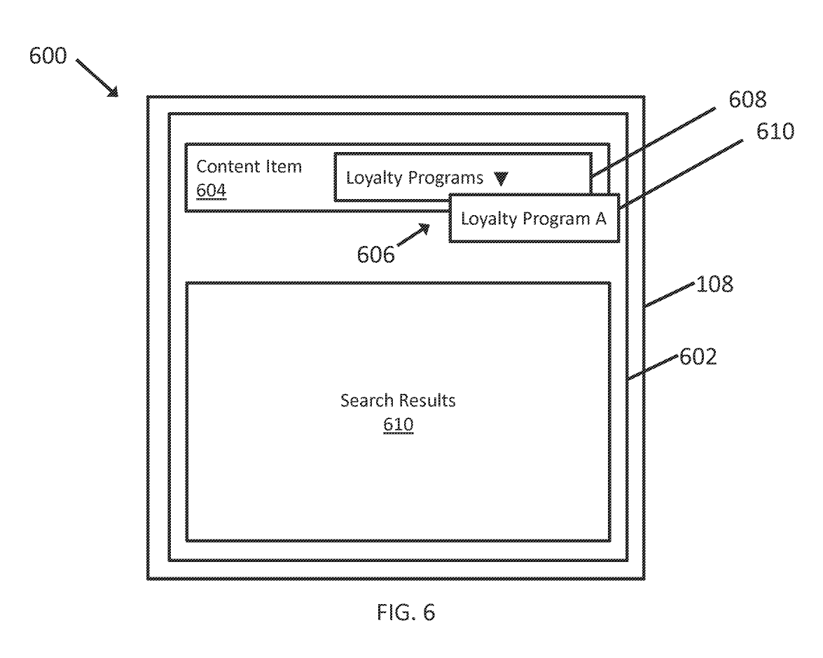

FIG. 6 is a diagram 600 of an example publication 602 that includes an annotated content item 604 in which the annotation 606 is in a menu format. Publication 602 is an example implementation of publication 408 transmitted from CMS 106 as part of response 406 (FIG. 4). Client computing device 108 displays publication 602 using output device 214 (FIG. 2). Annotation 606 includes a drop-down menu 608 that includes a menu item 610. Menu item 610 is a reference to loyalty program A 304. When clicked on or otherwise activated, for example using input device 212 (FIG. 2), client computing device 108 transmits request 410 to publisher server computing device 114, as described with reference to FIG. 4. In other words, menu item 610 functions as a link, similar to link 508 (FIG. 5). In some implementations, drop-down menu 608 includes multiple menu items. For example, in some implementations, each such menu item includes a reference to a different loyalty program that merchant B 320 is associated with.

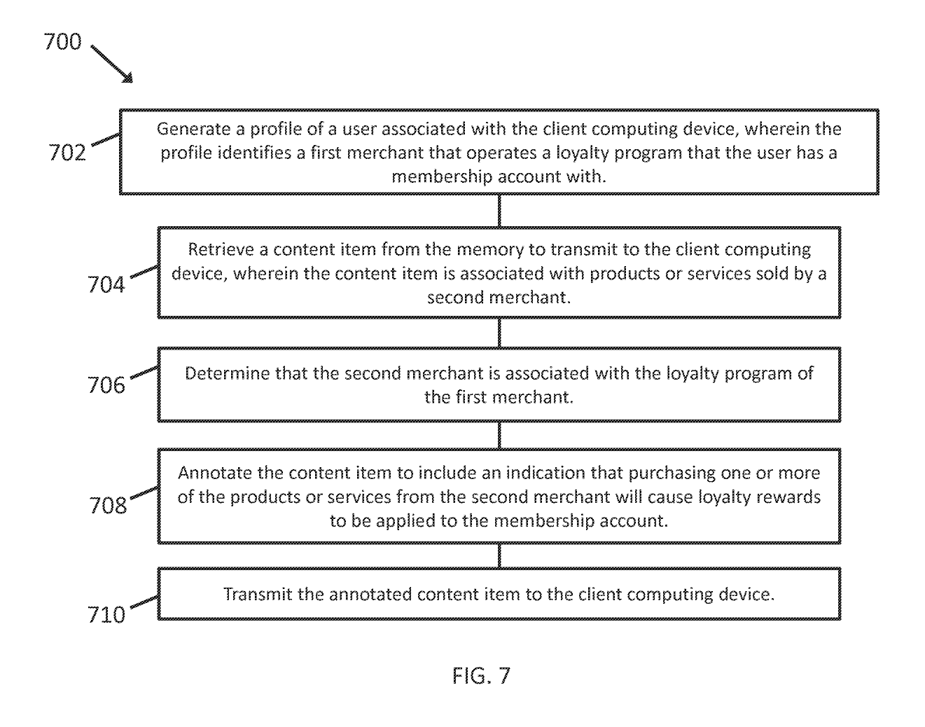

FIG. 7 is a flowchart of an example process 700 for annotating a content item, such as content item 504, to be displayed on a client computing device, such as client computing device 108. Process 700 is carried out by a server computing device, for example CMS 106. Initially, CMS 106 generates 702 a profile, such as profile 302, of a user, such as user 154, associated with client computing device 108. Profile 302 identifies a first merchant, such as merchant A 318, that operates a loyalty program, such as loyalty program A 304, that user 154 has a membership account with (e.g., membership account A 303). Additionally, CMS 106 retrieves 704 a content item, such as content item 504, from memory, such as content repository 126, to transmit to client computing device 108. Content item 504 is associated with products or services sold by a second merchant, such as merchant B 320. Additionally, CMS 106 determines 706 that the second merchant (e.g., merchant B 320) is associated with the loyalty program (e.g., loyalty program A 304) of the first merchant (merchant A 318). Further, CMS 106 annotates 708 the content item 504 to include an indication (e.g., annotation 506) that purchasing one or more of the products or services from the second merchant (e.g., merchant B 320) will cause loyalty rewards to be applied to membership account A 303. Additionally, CMS 106 transmits 710 the annotated content item 504 to client computing device 108.

In some implementations, in generating profile 302, CMS 106 determines that user 154 has membership account A 303 based on an electronic wallet (e.g., electronic wallet 310) associated with user 154. In some implementations, in generating profile 302, CMS 106 identifies at least one reference to loyalty program A 304 in an electronic message 312 transmitted to a messaging account associated with user 154 and determines, based at least in part on the identification of the reference in the electronic message, that user 154 has membership account A 303 with loyalty program A 304. In some implementations, in generating profile 302, CMS 106 detects an installation of at least one application 314 associated with merchant A 318 on client computing device 108 and determines, based at least in part on the detected installation, that user 154 has membership account A 303 for loyalty program A 304. In some implementations, in annotating the content item (e.g., content item 504), CMS 106 includes a link 508 to a webpage (e.g., landing page 414) of merchant B 320 that describes loyalty program A 304. In some implementations, CMS 106 determines that link 508 has been activated on client computing device 108, for example by receiving notification 416 from publisher server computing device 114 or from client computing device 108.

In some implementations, CMS 106 receives a search query, for example search query 402, transmitted from client computing device 108 and transmits the annotated content item 504 in response to search query 402, for example in response 406. In some implementations, CMS 106 selects content item 504 based, at least in part, on indication 301 of membership account A 303 in profile 302. In some implementations, in annotating content item 504, CMS 106 includes in the annotation 506 an indication 512 that the products or services may be purchased using an electronic wallet (e.g., electronic wallet 310). In some implementations, in annotating content item 504, CMS 106 includes instructions with content item 504 that, when executed by client computing device 108, cause client computing device 108 to display annotation 506 as a floating tag adjacent to content item 504. In some implementations, in annotating a content item (e.g., content item 604), CMS 106 includes instructions with content item 604 that, when executed by client computing device 108, cause client computing device 108 to display a menu 608 adjacent to content item 604 wherein the menu 608 includes a reference, such as menu item 610, to loyalty program A 304. In some implementations, in generating profile 302, CMS 106 determines that user 154 has an interest in loyalty program A 304 based on detecting that user 154 is following updates associated with merchant A 318 or has indicated support for merchant A 318 on a social networking site 316.

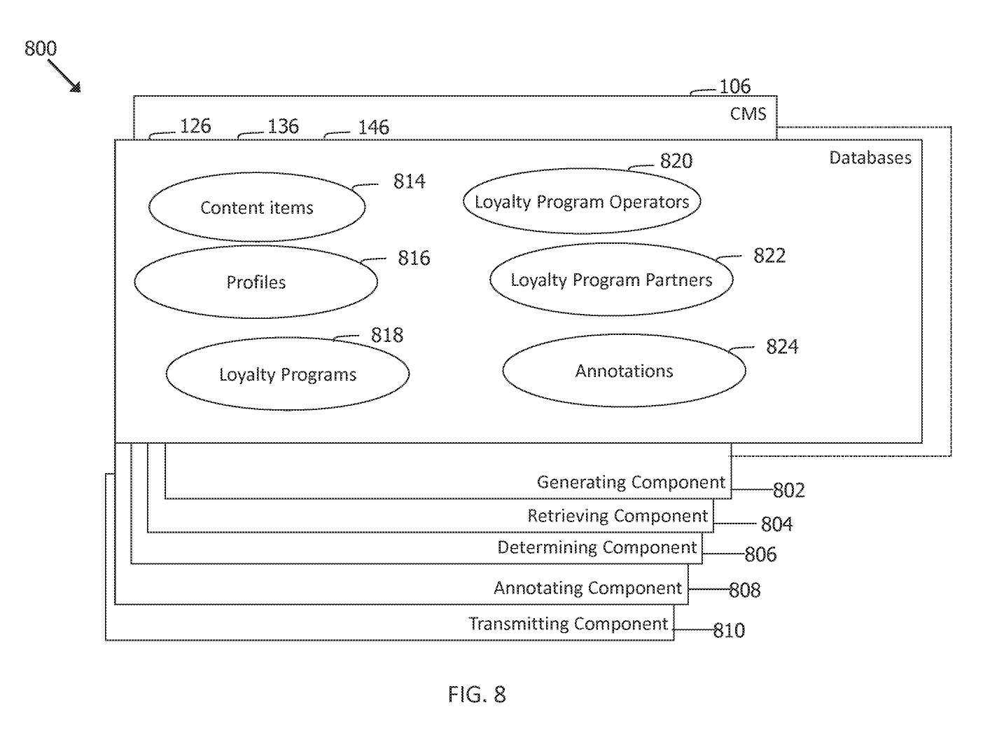

FIG. 8 is a diagram 800 of components of one or more example computing devices 200, that may be used in the environment shown in FIG. 1. For example, one or more of computing devices 200 may form content management system (CMS) 106. FIG. 8 further shows a configuration of databases 126, 136, and 146 (FIG. 1). Databases 126, 136, and 146 are coupled to several separate components within CMS 106, which perform specific tasks.

CMS 106 includes a generating component 802 for generating a profile (e.g. profile 302) of a user (e.g., user 154) associated with client computing device 108. The profile 302 identifies a first merchant (e.g., merchant A 318) that operates a loyalty program (e.g., loyalty program A 304) that user 154 has a membership account with (e.g., membership account A 303). Additionally, CMS 106 includes a retrieving component 804 that retrieves a content item (e.g., content item 504) from a memory (e.g., content repository 126) to transmit to the client computing device 108. The content item 504 is associated with products or services sold by a second merchant (e.g., merchant B 320). Additionally, CMS 106 includes a determining component 806 that determines that the second merchant (e.g., merchant B 320) is associated with the loyalty program (e.g., loyalty program A 304) of the first merchant (e.g., merchant A 318). Additionally, CMS 106 includes an annotating component 808 that annotates the content item 504 to include an indication that purchasing one or more of the products or services from the second merchant (e.g., merchant B 320) will cause loyalty rewards to be applied to the membership account (e.g., membership account A 303). Additionally, CMS 106 includes a transmitting component 810 that transmits the annotated content item 504 to the client computing device 108.

In an exemplary embodiment, databases 126, 136, and 146 are divided into a plurality of sections, including but not limited to, a content items section 814, a profiles section 816, a loyalty programs section 818, a loyalty program operators section 820, a loyalty program partners section 822, and an annotations section 824. These sections within databases 126, 136, and 146 are interconnected for use in performing the operations described herein.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or variations that may be included.

Also, the particular naming of the components, capitalization of terms, the attributes, data structures, or any other programming or structural aspect is not mandatory or significant, and the mechanisms that implement the subject matter described herein or its features may have different names, formats, or protocols. Further, the system may be implemented via a combination of hardware and software, as described, or entirely in hardware elements. Also, the particular division of functionality between the various system components described herein is merely for the purposes of example only, and not mandatory; functions performed by a single system component may instead be performed by multiple components, and functions performed by multiple components may instead performed by a single component.

Some portions of the above description may present features in terms of algorithms and symbolic representations of operations on information. Such algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

1. A method for annotating a content item to be displayed on at least one client computing device having a display, the method implemented by a server computing device that is communicatively coupled to a memory and to the at least one client computing device, the method comprising:
generating a profile of a user associated with the client computing device, wherein the profile identifies a first merchant that operates a loyalty program that the user has a membership account with;
retrieving a content item from the memory to transmit to the client computing device, wherein the content item is associated with products or services sold by a second merchant;
determining that the second merchant is associated with the loyalty program of the first merchant;
annotating the content item to include an indication that purchasing one or more of the products or services from the second merchant will cause loyalty rewards to be applied to the membership account and to include a link to a webpage of the second merchant;
transmitting the annotated content item to the client computing device; and
detecting, subsequent to transmitting the annotated content item, that the link has been activated on the client computing device.

2. The method of claim 1, wherein generating the profile further comprises determining that the user has the membership account associated with the loyalty program of the first merchant based on an electronic wallet associated with the user.

3. The method of claim 1, wherein generating the profile further comprises:
identifying at least one reference to the loyalty program in an electronic message transmitted to a messaging account associated with the user; and
determining, based at least in part on the identification of the reference in the electronic message, that the user has the membership account associated with the loyalty program of the first merchant.

4. The method of claim 1, wherein generating the profile further comprises:
detecting an installation of at least one application associated with the first merchant on the client computing device; and
determining, based at least in part on the detected installation, that the user has a membership account associated with the loyalty program of the first merchant.

5. (canceled)

6. (canceled)

7. The method of claim 1, further comprising:
receiving a search query transmitted from the client computing device; and
transmitting the annotated content item in response to the search query.

8. The method of claim 7, further comprising:
selecting the content item from a plurality of content items stored in the memory based at least in part on the membership account.

9. The method of claim 1, wherein annotating the content item further comprises including in the annotation an indication that the products or services may be purchased using an electronic wallet.

10. The method of claim 1, wherein annotating the content item further comprises including instructions with the content item that, when executed by the client computing device, cause the client computing device to display a floating tag adjacent to the content item.

11. The method of claim 1, wherein annotating the content item further comprises including instructions with the content item that, when executed by the client computing device, cause the client computing device to display a menu adjacent to the content item, wherein the menu includes a reference to the loyalty program.

12. The method of claim 1, wherein generating the profile further comprises determining that the user has an interest in the loyalty program based on detecting that the user is following updates associated with the first merchant or has indicated support for the first merchant on a social networking site.

13. A server computing device for annotating a content item to be displayed on at least one client computing device having a display, said server computing device is communicatively coupled to a memory and to the at least one client computing device, said server computing device is configured to:
generate a profile of a user associated with the client computing device, wherein the profile identifies a first merchant that operates a loyalty program that the user has a membership account with;
retrieve a content item from the memory to transmit to the client computing device, wherein the content item is associated with products or services sold by a second merchant;
determine that the second merchant is associated with the loyalty program of the first merchant;
annotate the content item to include an indication that purchasing one or more of the products or services from the second merchant will cause loyalty rewards to be applied to the membership account and to include a link to a webpage of the second merchant;
transmit the annotated content item to the client computing device; and
detect, subsequent to the transmission of the annotated content item, that the link has been activated on the client computing device.

14. The server computing device of claim 13, further configured such that generating the profile further comprises determining that the user has the membership account associated with the loyalty program of the first merchant based on an electronic wallet associated with the user.

15. The server computing device of claim 13, further configured such that generating the profile further comprises:
identifying at least one reference to the loyalty program in an electronic message transmitted to a messaging account associated with the user; and
determining, based at least in part on the identification of the reference in the electronic message, that the user has the membership account associated with the loyalty program of the first merchant.

16. The server computing device of claim 13, further configured such that generating the profile further comprises:
detecting an installation of at least one application associated with the first merchant on the client computing device; and
determining, based at least in part on the detected installation, that the user has a membership account associated with the loyalty program of the first merchant.

17. (canceled)

18. (canceled)

19. The server computing device of claim 13, further configured to:
receive a search query transmitted from the client computing device; and
transmit the annotated content item in response to the search query.

20. A non-transitory computer-readable storage device having processor-executable instructions embodied thereon, for annotating a content item to be displayed on at least one client computing device having a display, wherein when executed by a server computing device communicatively coupled to a memory and to the at least one client computing device, the processor-executable instructions cause the server computing device to perform the steps of:
generating a profile of a user associated with the client computing device, wherein the profile identifies a first merchant that operates a loyalty program that the user has a membership account with;
retrieving a content item from the memory to transmit to the client computing device, wherein the content item is associated with products or services sold by a second merchant;
determining that the second merchant is associated with the loyalty program of the first merchant;
annotating the content item to include an indication that purchasing one or more of the products or services from the second merchant will cause loyalty rewards to be applied to the membership account and to include a link to a webpage of the second merchant;
transmitting the annotated content item to the client computing device; and
detecting, subsequent to the transmission of the annotated content item, that the link has been activated on the client computing device.
